(19) United States
(12) Patent Application Publication
(10) Pub. No.: US 2024/0012599 A1
(43) Pub. Date: Jan. 11, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TAKAAKI KATO, TOKYO (JP); SHINGO TSURUMI, TOKYO (JP)

(21) Appl. No.: 18/252,363

(22) PCT Filed: Sep. 24, 2021
(86) PCT No.: PCT/JP2021/035048

§ 371 Date: May 9, 2023

(30) Foreign Application Priority Data
Nov. 17, 2020 (JP) 2020-190636

(51) Int. Cl. G06F 3/14; G06T 7/73; G10L 15/22; G06T 13/00; G06T 7/50

(52) U.S. Cl. CPC G06F 3/1423; G06T 7/73; G10L 15/22; G06T 13/00; G06T 7/50; G06T 2207/30204; G06T 2200/04

(57) ABSTRACT

[Object]

An object is to achieve rendering of movement of a conversational agent, the rendering being less uncomfortable for a user. [Solving Means] Provided is an information processing apparatus that includes a control section that controls display, in a display region present on a predetermined three-dimensional space, of a display object corresponding to a conversational agent that supports provision of a function for a user while engaging in conversation with the user. The control section dynamically controls display of an animation related to at least any one of representation of the display object moving out from the display region or representation of the display object moving into the display region, on the basis of a relative position between a predetermined target object present on the three-dimensional space and the display object.

### TECHNICAL FIELD

The present disclosure relates to an information processing apparatus, an information processing method, and a program.

### BACKGROUND ART

In recent years, conversational agents that support provision of functions for a user while engaging in conversation with the user have widely been used. In addition, there have been proposed technologies in which a single conversational agent is shared among multiple pieces of electronic equipment. For example, PTL 1 discloses a conversational agent that moves between pieces of electronic equipment on the basis of conversion with the user.

### CITATION LIST

### Patent Literature

### [PTL 1]

JP 2015-115879A

### SUMMARY

### Technical Problem

As disclosed in PTL 1, in a case where movement of a conversational agent is controlled, rendering movement representation that is less uncomfortable for the user is important.

### Solution to Problem

An aspect of the present disclosure provides an information processing apparatus including a control section that controls display, in a display region present on a predetermined three-dimensional space, of a display object corresponding to a conversational agent that supports provision of a function for a user while engaging in conversation with the user. The control section dynamically controls display of an animation related to at least any one of representation of the display object moving out from the display region or representation of the display object moving into the display region, on the basis of a relative position between a predetermined target object present on the three-dimensional space and the display object.

In addition, another aspect of the present disclosure provides an information processing method including a processor that controls display, in a display region present on a predetermined three-dimensional space, of a display object corresponding to a conversational agent that supports provision of a function for a user while engaging in conversation with the user. The controlling further includes dynamically controlling display of an animation related to at least any one of representation of the display object moving out from the display region or representation of the display object moving into the display region, on the basis of a relative position between a predetermined target object present on the three-dimensional space and the display object.

In addition, another aspect of the present disclosure provides a program causing a computer to function as an information processing apparatus including a control section that controls display, in a display region present on a predetermined three-dimensional space, of a display object corresponding to a conversational agent that supports provision of a function for a user while engaging in conversation with the user. The control section dynamically controls display of an animation related to at least any one of representation of the display object moving out from the display region or representation of the display object moving into the display region, on the basis of a relative position between a predetermined target object present on the three-dimensional space and the display object.

### BRIEF DESCRIPTION OF DRAWINGS

FIG. 1 is a diagram for describing an outline of movement control of a conversational agent according to an embodiment of the present disclosure.

FIG. 2 is a block diagram depicting a functional configuration example of electronic equipment 10 according to the embodiment.

FIG. 3 is a block diagram depicting a functional configuration example of an information processing server 20 according to the embodiment.

FIG. 4 is a diagram depicting an example of display control of a display object AO, the display control being performed in a case where a target object according to the embodiment is the electronic equipment 10 including a display region.

FIG. 5 is a diagram depicting an example of display control of the display object AO, the display control being performed in the case where the target object according to the embodiment is the electronic equipment 10 including the display region.

FIG. 6 is a diagram depicting an example of display control of the display object AO, the display control being performed in a case where the target object according to the embodiment is the electronic equipment 10 including no display region.

FIG. 7 is a diagram depicting an example of display control of the display object AO, the display control being performed in the case where the target object according to the embodiment is the electronic equipment 10 including no display region.

FIG. 8 is a flowchart illustrating an example of a flow of identification of the target object based on designation provided by a user, and display control of the display object AO, according to the embodiment.

FIG. 9 is a flowchart illustrating an example of a flow of identification of the target object based on a direction designated by the user, and display control of the display object AO, according to the embodiment.

FIG. 10 is a flowchart illustrating an example of a flow of identification of the target object based on detection of a movement trigger related to a context, and display control of the display object AO, according to the embodiment.

FIG. 11 is a sequence diagram depicting an example of a flow of registration processing executed in a case where an object to be registered is the electronic equipment 10 including an image capturing section 120, according to the embodiment.

FIG. 12 is a sequence diagram depicting an example of a flow of registration processing executed in a case where the object to be registered is the electronic equipment 10 not including the image capturing section 120 but including a display section 160, according to the embodiment.

FIG. 13 is a sequence diagram depicting an example of a flow of registration processing executed in a case where the object to be registered is the electronic equipment 10 not including the image capturing section 120 and the display section 160, according to the embodiment.

FIG. 14 is a block diagram depicting a hardware configuration example of an information processing apparatus 90 according to the embodiment.

### DESCRIPTION OF EMBODIMENT

A preferred embodiment of the present disclosure will hereinafter be described in detail with reference to the accompanying drawings. Note that, in the present specification and drawings, components having substantially the same functions and configurations are denoted by the same reference signs to omit duplicate descriptions.

Note that the description will be given in the following order.
1. Embodiment
   1.1 Outline
   1.2 Functional Configuration Example of Electronic Equipment 10
   1.3 Functional Configuration Example of Information Processing Server 20
   1.4 Display Control of Display Object AO
   1.5 Identification of Target Object
   1.6 Registration of Candidates That Can Each Be Used as Target Object
2. Hardware Configuration Example
3. Summary

### 1. Embodiment

### <<1.1 Outline>>

As described above, in recent years, conversational agents that support provision of functions for a user while engaging in conversation with the user have widely been used.

By using a conversational agent as described above, the user can perform various operations such as execution and stoppage of functions and search for information.

In addition, the conversational agent can be mounted in various types of electronic equipment, for example, a smartphone, a PC (Personal Computer), a TV (television), a wearable device including a head-mounted display, game equipment, a dedicated apparatus, and the like.

Here, in a case where each type of electronic equipment uses a separate conversational agent, operation is cumbersome, and sharing history related to conversations with the user is difficult. Hence, function support capabilities for the user can be degraded.

Accordingly, in a case where multiple pieces of electronic equipment are present on a predetermined three-dimensional space, a single conversational agent is assumed to be shared among the multiple pieces of electronic equipment.

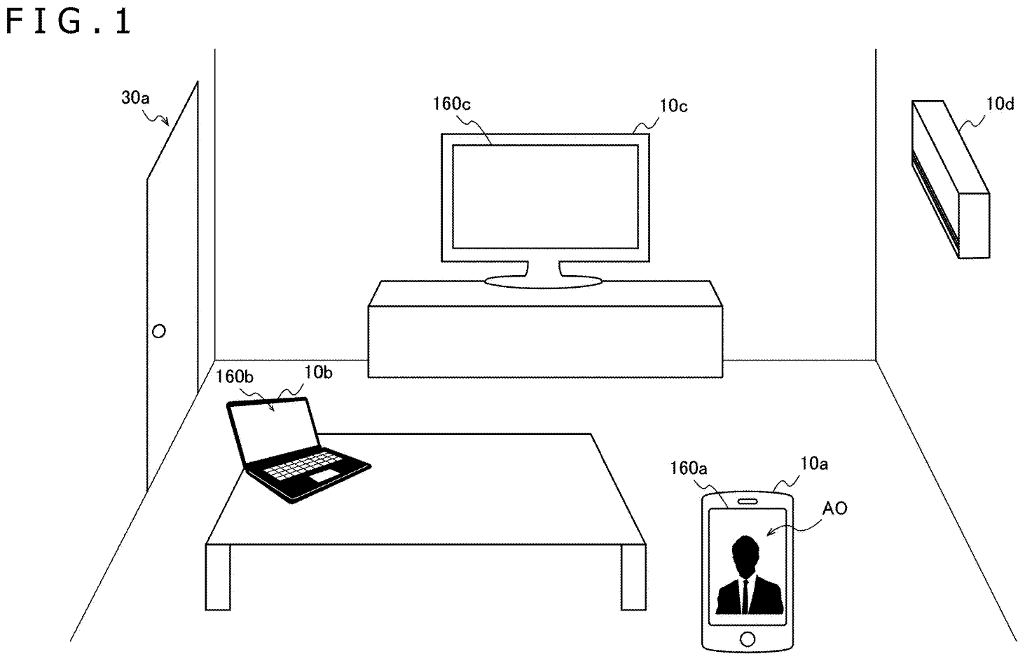

FIG. 1 is a diagram for describing an outline of movement control of a conversational agent according to an embodiment of the present disclosure.

FIG. 1 depicts an example of a case in which, in a house of a user (an example of a predetermined three-dimensional space), three pieces of electronic equipment 10a to 10c that include respective display sections 160a to 160c are present.

Note that, in the example of the case illustrated in FIG. 1, electronic equipment 10a may be a smartphone, electronic equipment 10b may be a laptop computer, and electronic equipment 10c may be a TV.

As described above, in a case where multiple pieces of electronic equipment 10 are present on the predetermined three-dimensional space, when it is possible to share a single conversational agent among the multiple pieces of electronic equipment 10, the cumbersomeness of user operation can be reduced, while the convenience of the user operation can be improved.

For example, in FIG. 1, the user is engaging in conversation with the conversational agent by using the electronic equipment 10a corresponding to a smartphone. At this time, a display section 160a provided in the electronic equipment 10a may display a display object AO corresponding to the conversational agent.

Here, assumed is a case where the user attempts to operate a function of the electronic equipment 10b corresponding to a laptop computer. In this case, by causing an animation to be displayed, the animation depicting the display object AO that is being displayed on the display section 160a of the electronic equipment 10a and appears to move to a display section 160b of the electronic equipment 10b, the subject of the conversational agent can be rendered to have moved (shifted) to the electronic equipment 10b.

The control as described above enables the user to view the display object AO displayed on the display section 160b of the electronic equipment 10b, to continue conversation with the conversational agent via the electronic equipment 10b.

Similarly, assumed is a case where the user attempts to operate a function of the electronic equipment 10c corresponding to a TV. In this case, by causing an animation to be displayed, the animation depicting the display object AO that is being displayed on the display section 160a of the electronic equipment 10a and appears to move to a display section 160c of the electronic equipment 10c, the subject of the conversational agent can be rendered to have moved (shifted) to the electronic equipment 10c.

The control as described above enables the user to view the display object AO displayed on the display section 160c of the electronic equipment 10c, to continue conversation with the conversational agent via the electronic equipment 10c.

In addition, in a case where the movement representation related to the display object AO as described above is controlled, performing rendering that is less uncomfortable for the user is important.

For example, in a positional relation depicted in FIG. 1, assumed is a case where the subject of the conversational agent is moved (shifted) from the electronic equipment 10a to the electronic equipment 10b. In this case, by causing an animation to be displayed on the display section 160a of the electronic equipment 10a, the animation depicting the display object AO moving toward the electronic equipment 10b with reference to the display section 160a of the electronic equipment 10a, rendering that is less uncomfortable for the user can be achieved.

Similarly, on the display section 160b of the electronic equipment 10b, by causing an animation to be displayed, the animation depicting the display object AO moving from the electronic equipment 10a with reference to the display section 160b of the electronic equipment 10b, rendering that is less uncomfortable for the user can be achieved.

For this purpose, the information processing server 20 that controls multiple pieces of electronic equipment 10 according to an embodiment of the present disclosure includes a control section 260 that controls display, in a display region present on the predetermined three-dimensional space, of the display object AO corresponding to the conversational agent that supports provision of functions for the user while engaging in conversation with the user.

In addition, a feature of the control section 260 according to an embodiment of the present disclosure is that the control section 260 dynamically controls display of an animation related to at least any one of representation of the display object AO moving out from the display region or the display object AO moving into the display region, on the basis of the relative position between the display object (display region provided in the electronic equipment corresponding to a movement source) and a target object present on the three-dimensional space.

Note that, here, the above-described target object includes the electronic equipment 10 including the display section 160 like the pieces of electronic equipment 10a to 10c, for example.

The control as described above enables achievement of movement representation that is related to the display object AO and that is less uncomfortable for the user.

In addition, the target object according to the present embodiment is not limited to the electronic equipment 10 including the display section 160.

For example, in the example illustrated in FIG. 1, in addition to the pieces of electronic equipment 10a to 10c, electronic equipment 10d not including the display section 160 is present on the three-dimensional space.

In the example illustrated in FIG. 1, the electronic equipment 10d may be an air conditioner.

The target object according to the present embodiment may include the electronic equipment 10 not including the display section 160 like the electronic equipment 10d.

For example, assumed is a case where the user attempts to operate a function of the electronic equipment 10d while engaging in conversation with the conversational agent by using the electronic equipment 10a.

In this case, needless to say, with the display object AO displayed on the display section 160, the function of the electronic equipment 10d can be controlled.

Meanwhile, assumed is a case where the function of the electronic equipment 10d is controlled after an animation that depicts the display object AO moving toward the electronic equipment 10d is caused to be displayed. In this case, rendering that makes the conversational agent appear to have moved to control the function of the electronic equipment 10d can be performed. This is expected to be effective in giving the user a feeling that the conversational agent is actually present on the three-dimensional space.

In addition, the target object according to the present embodiment may include, in addition to the electronic equipment 10, various structures present on the three-dimensional space.

For example, in the case of the example illustrated in FIG. 1, in addition to the electronic equipment 10a to 10d, a structure 30a is present on the three-dimensional space.

In the case of the example illustrated in FIG. 1, the structure 30a may be a front door provided in the house of the user.

Here, for example, assumed is a case where the user uses the electronic equipment 10a to ask the conversational agent the current weather around the house (three-dimensional space).

In this case, the control section 260 of the information processing server 20 may, for example, cause the display section 160a of the electronic equipment 10a to display an animation of the display object AO moving toward the structure 30a, and to then display an animation of the display object AO moving from the structure 30a.

Further, the control section 260 may cause a sound output section 150 provided in the electronic equipment 10a to output, for example, a sound indicating that “I checked the outside of the house to find it is fine now.”

At this time, the control section 260 can generate such a response as described above by acquiring, via the Internet, weather information regarding the neighborhood of the house of the user. In addition, the control section 260 can estimate the weather from an image captured by a camera located outside the house.

The control as described above enables achievement of rendering that makes the conversational agent appear to have checked the outside weather via the structure 30a corresponding to the front door. This is expected to be effective in giving the user the feeling that the conversational agent is actually present on the three-dimensional space.

The outline of the present embodiment has been described hereinabove. Now, an example of a system configuration that implements such control as described above will be described in detail.

### <<1.2. Functional Configuration Example of Electronic Equipment 10>>

First, a functional configuration example of the electronic equipment 10 according to the present embodiment will be described. The electronic equipment 10 according to the present embodiment may be equipment that can correspond to the subject of the conversational agent, for example, like the electronic equipment 10a depicted in FIG. 1. In addition, the electronic equipment 10 according to the present embodiment may be equipment corresponding to a target of function provision support provided by the conversational agent, like the electronic equipment 10d depicted in FIG. 1.

In addition, the electronic equipment 10 according to the present embodiment has some of the functions thereof controlled by the information processing server 20. An example of the functions includes display control of the display object AO.

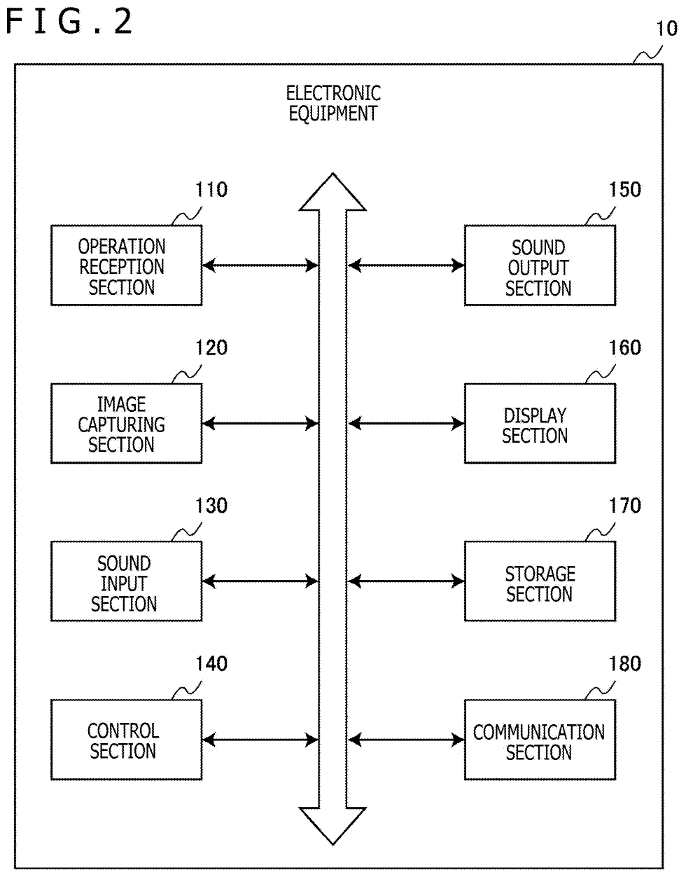

FIG. 2 is a block diagram depicting a functional configuration example of the electronic equipment 10 according to the present embodiment. As depicted in FIG. 1, the electronic equipment 10 according to the present embodiment may include an operation reception section 110, an image capturing section 120, a sound input section 130, a control section 140, a sound output section 150, a display section 160, a storage section 170, a communication section 180, and the like.

### (Operation Reception Section 110)

The operation reception section 110 according to the present embodiment receives operation performed by the user. For this purpose, the operation reception section 110 according to the present embodiment includes various input devices such as a keyboard, a button, a touch panel, and a mouse.

### (Image Capturing Section 120)

The image capturing section 120 according to the present embodiment captures an image of surroundings of the electronic equipment 10. For this purpose, the image capturing section 120 according to the present embodiment includes various image capturing devices.

### (Sound Input Section 130)

The sound input section 130 according to the present embodiment collects various sounds such as the voice of the user. For this purpose, the sound input section 130 according to the present embodiment includes a microphone and the like.

### (Control Section 140)

The control section 140 according to the present embodiment controls each of the components provided in the electronic equipment 10. By way of example, the control section 140 may cooperate with the control section 260 of the information processing server 20 in controlling display of the display object AO.

The functions of the control section 140 according to the present embodiment are implemented by various processors.

### (Sound Output Section)

The sound output section 150 according to the present embodiment outputs various sounds. By way of example, the sound output section 150 according to the present embodiment may output a sound corresponding to utterance of the conversational agent. For this purpose, the sound output section 150 according to the present embodiment includes a speaker, an amplifier, and the like.

### (Display Section 160)

The display section 160 according to the present embodiment displays various types of visual information according to control of the control section 140 and the control section 260 of the information processing server 20.

By way of example, the display section 160 according to the present embodiment displays the display object AO corresponding to the conversational agent. For this purpose, the display section 160 according to the present embodiment includes various displays.

Note that the display section 160 is an example of a display region. The display region may be implemented by, in addition to the display section 160, projection performed by a projector.

### (Storage Section 170)

The storage section 170 according to the present embodiment stores information used by each of the components provided in the electronic equipment 10. For example, the storage section 170 may store programs used by the control section 140 and other kinds of information. In addition, the storage section 170 may store an identifier of the electronic equipment 10.

The above-mentioned identifier may be information for identifying the electronic equipment 10 on the network. Examples of the identifier include an IP address, a MAC address, and the like.

### (Communication Section 180)

The communication section 180 according to the present embodiment performs information communication with the information processing server 20. The information communication includes wireless communication and wired communication.

Examples of the wireless communication include wireless LAN such as Wi-Fi (registered trademark), ZigBee (registered trademark), Bluetooth (registered trademark), and communication using electronic tags.

The functional configuration example of the electronic equipment 10 according to the present embodiment has been described hereinabove. Note that the functional configuration described above using FIG. 2 is only an example and that the functional configuration of the electronic equipment 10 according to the present embodiment is not limited to such an example.

For example, the electronic equipment 10 according to the present embodiment need not necessarily include the image capturing section 120, the sound input section 130, the sound output section 150, the display section 160, or the like.

In addition, the electronic equipment 10 according to the present embodiment may further include an acceleration sensor, a gyro sensor, or the like for detecting the posture.

The functional configuration of the electronic equipment 10 according to the present embodiment can flexibly be varied according to the characteristics of the electronic equipment 10.

### <<1.3. Functional Configuration Example of Information Processing Server 20>>

Now, a functional configuration example of the information processing server 20 according to the present embodiment will be described. The information processing server 20 according to the present embodiment is an information processing apparatus that controls multiple pieces of the electronic equipment 10.

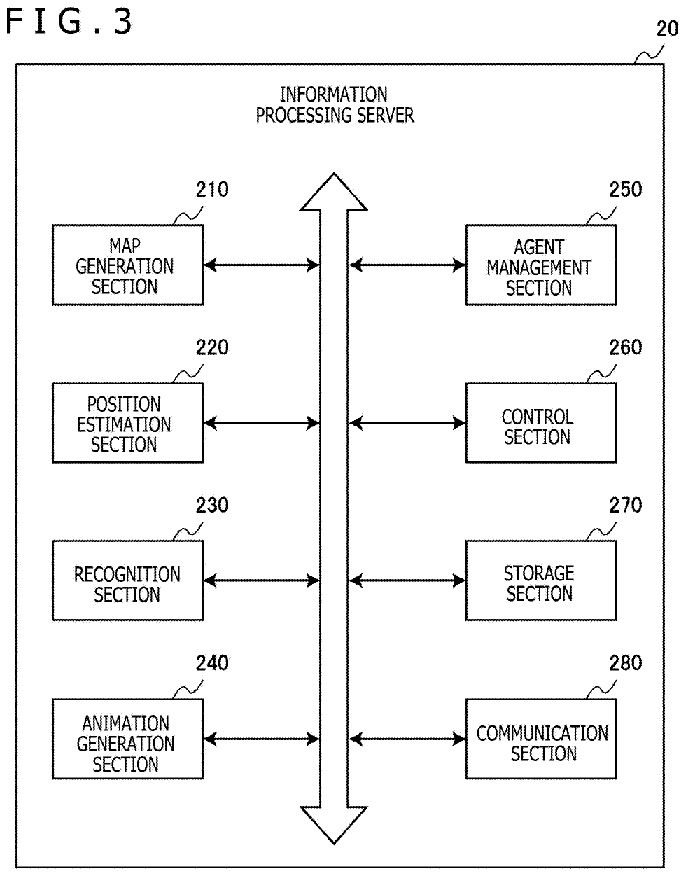

FIG. 3 is a block diagram depicting a functional configuration example of the information processing server 20 according to the present embodiment. As depicted in FIG. 3, the information processing server 20 according to the present embodiment includes a map generation section 210, a position estimation section 220, a recognition section 230, an animation generation section 240, an agent management section 250, the control section 260, a storage section 270, a communication section 280, and the like.

### (Map Generation Section 210)

The map generation section 210 according to the present embodiment generates three-dimensional map information related to the predetermined three-dimensional space. The map generation section 210 may adopt a technique widely used in the field of image processing, to generate three-dimensional map information.

An example of the above-described technique includes RGBD-ICP in which a group of three-dimensional points acquired by an RGB-D camera is superimposed on image feature points, for example.

The three-dimensional map information generated by the map generation section 210 is stored in the storage section 270.

### (Position Estimation Section 220)

The position estimation section 220 according to the present embodiment estimates the position of the electronic equipment 10 on the three-dimensional space on the basis of the three-dimensional map information generated by the map generation section 210 and an image captured by the electronic equipment 10, for example.

### (Recognition Section 230)

The recognition section 230 according to the present embodiment recognizes objects such as the electronic equipment 10 and the structure 30 on the basis of an input image.

In addition, the recognition section 230 according to the present embodiment may recognize sounds on the basis of the sound of the user acquired by the electronic equipment 10.

The recognition section 230 may perform the recognition as described above, for example, using a recognizer generated by machine learning.

### (Animation Generation Section 240)

The animation generation section 240 according to the present embodiment generates an animation related to the display object AO corresponding to the conversational agent, on the basis of control performed by the control section 260.

### (Agent Management Section 250)

The agent management section 250 according to the present embodiment controls conversation between the conversational agent and the user. By way of example, the agent management section 250 according to the present embodiment performs generation of a response provided by the conversational agent, for example.

### (Control Section 260)

The control section 260 according to the present embodiment controls the components provided in the information processing server 20 and also controls the electronic equipment 10.

By way of example, the control section 260 according to the present embodiment controls display, in a display region present on the predetermined three-dimensional space, of the display object AO corresponding to the conversational agent that supports provision of the functions for the user while engaging in conversation with the user.

In addition, a feature of the control section 260 according to the present embodiment is that the control section 260 dynamically controls display of an animation related to at least any one of representation of the display object AO moving out from the display region or representation of the display object AO moving into the display region, on the basis of the relative position between the display object and a predetermined target object present on the three-dimensional space.

The functions of the control section 260 according to the present embodiment will separately be described in detail. Note that the functions of the control section 260 according to the present embodiment are implemented by various processors.

### (Storage Section 270)

The storage section 270 according to the present embodiment stores information used by the components provided in the information processing server 20.

For example, the storage section 270 according to the present embodiment stores three-dimensional map information related to the predetermined three-dimensional space and generated by the map generation section 210.

In addition, the storage section 270 according to the present embodiment stores an identifier of the target object in association with the position of the target object on the three-dimensional space.

### (Communication Section 280)

The communication section 280 according to the present embodiment performs information communication with the electronic equipment 10.

The functional configuration example of the information processing server 20 according to the present embodiment has been described hereinabove. Note that the functional configuration described above using FIG. 3 is only an example and that the functional configuration of the information processing server 20 according to the present embodiment is not limited to such an example.

For example, the functions of the components described above may be implemented by cooperation among multiple apparatuses.

The functional configuration of the information processing server 20 according to the present embodiment can flexibly be varied according to specifications and operations.

### <<1.4. Display Control of Display Object AO>>

Now, display control of the display object AO according to the present embodiment will be described in detail with reference to specific examples.

As described above, a feature of the control section 260 of the information processing server 20 according to the present embodiment is that the control section 260 dynamically controls display of an animation related to at least any one of representation of the display object AO moving out from the display region or representation of the display object AO moving into the display region, on the basis of the positional relation between the target object and the display object.

More specifically, the control section 260 according to the present embodiment may dynamically control display of an animation related to at least any one of representation of the display object AO moving out from the display region toward the target object with reference to the display region or representation of the display object AO moving into the display region from the target object with reference to the display region.

The control as described above enables achievement of rendering of movement, the rendering being less uncomfortable for the user.

Note that, as described above, the target object according to the present embodiment includes predetermined electronic equipment 10 performing a function provided to the user. In this case, the control section 260 according to the present embodiment may dynamically control the animation related to the representation of the display object AO moving out from the display region toward the electronic equipment 10 with reference to the display region.

First, description will be given of an example of the display control of the display object AO, the display control being performed in a case where the target object according to the present embodiment is the electronic equipment 10 including the display region.

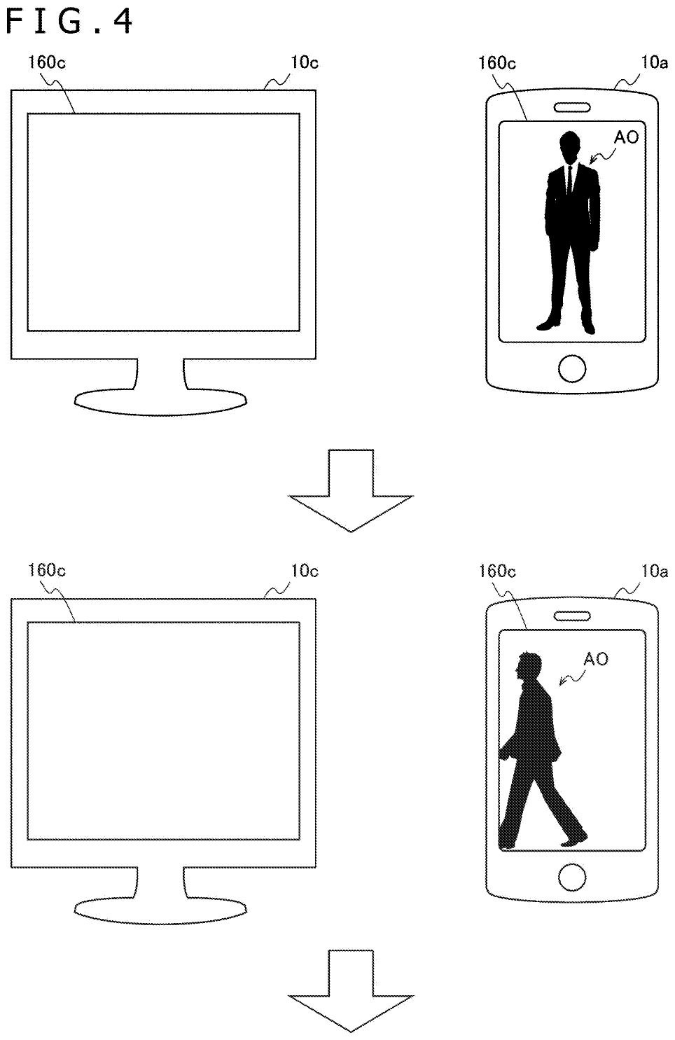

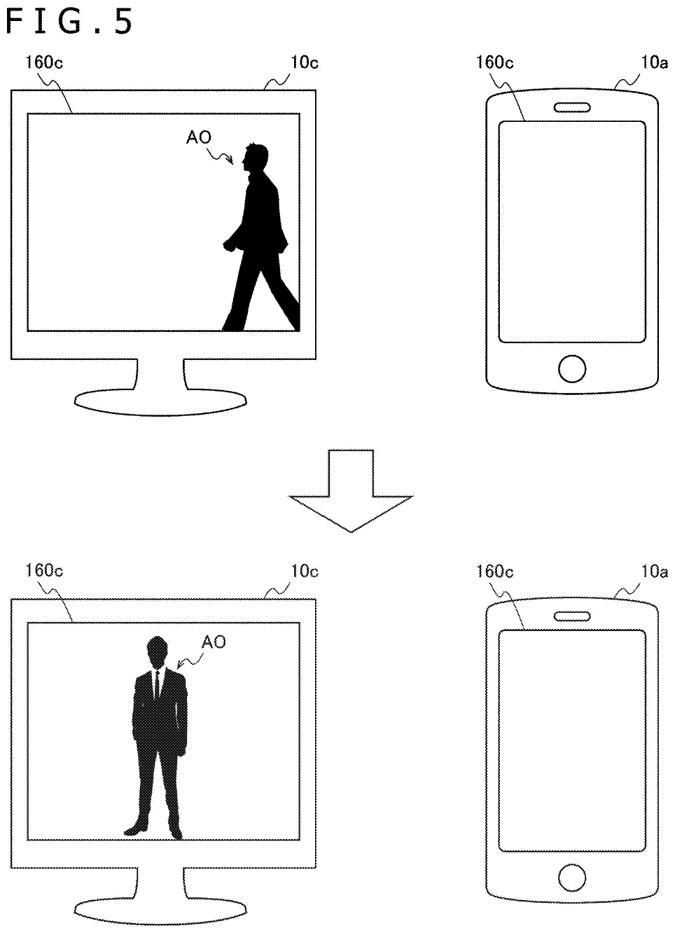

FIGS. 4 and 5 are diagrams illustrating an example of the display control of the display object AO, the display control being performed in a case where the target object according to the present embodiment is the electronic equipment 10 including the display region.

Note that FIGS. 4 and 5 illustrate an example in which the electronic equipment 10a corresponding to a movement source of the display object AO is a smartphone whereas the electronic equipment 10c corresponding to a movement destination of the display object AO is a TV.

In addition, in the example illustrated in FIGS. 4 and 5, the electronic equipment 10c is positioned to the left of the electronic equipment 10a on the three-dimensional space.

In this case, first, as depicted in the upper stage in FIG. 4, the user views the display object AO displayed on the display section 160a (corresponding to a first display region) of the electronic equipment 10a and has conversation with the conversational agent.

Here, for example, assumed is a case where the user utters the desire of the user to operate a function (for example, display of a TV guide) of the electronic equipment 10c corresponding to a TV.

In this case, the control section 260 of the information processing server 20 causes the animation generation section 240 to generate, in the display section 160a of the electronic equipment 10a that is displaying the display object AO, an animation related to representation of the display object AO moving toward the display section 160c (corresponding to a second display region) provided in the electronic equipment 10c.

In addition, as depicted in the lower stage in FIG. 4, the control section 260 dynamically controls display of the above-described animation provided by the display section 160a of the electronic equipment 10a.

In addition, the control section 260 causes the animation generation section 240 to generate, in the display section 160c of the electronic equipment 10c, an animation related to representation of the display object AO moving from the display section 160a of the electronic equipment 10a.

In addition, as depicted in the upper stage in FIG. 5, the control section 260 dynamically controls display of the above-described animation provided by the display section 160c of the electronic equipment 10c.

Further, after completing the control of the animation described above, the control section 260 may cause the display section 160c of the electronic equipment 1Cc to display an animation of the display object AO appearing to face the user as depicted in the lower stage in FIG. 5.

The control as described above enables more natural rendering of movement (shifting) of the conversational agent from the electronic equipment 10a to the electronic equipment 1Cc.

Note that, in FIGS. 4 and 5, depicted is the case where the display section 160c of the electronic equipment 1Cc is positioned outside the image capturing range of an image capturing section 120a provided in the electronic equipment 10a. Meanwhile, a case where the display section 160c of the electronic equipment 10c is positioned within the image capturing range of the image capturing section 120a provided in the electronic equipment 10a can also be assumed.

In this case, the control section 260 may cause the display section 160a of the electronic equipment 10a to display an image (that is, a captured image) that includes the display section 160c of the electronic equipment 10c and that is captured by the image capturing section 120a provided in the electronic equipment 10a, and may further superimpose the display object AO on the display section 160a.

In addition, in this case, the control section 260 may cause the animation generation section 240 to generate an animation related to representation of the display object AO moving toward the display section 160c of the electronic equipment 10c displayed on the display section 160a of the electronic equipment 10a, and may cause the display section 160a to display the animation.

In contrast, the control section 260 may cause the animation generation section 240 to generate an animation related to representation of the display object AO moving forward (that is, toward the user viewing the display section 160) from the display section 160c of the electronic equipment 10c displayed on the display section 160a of the electronic equipment 10a, and may cause the display section 160a to display the animation.

By referencing the three-dimensional map information related to the predetermined three-dimensional space and positional information regarding the electronic equipment 10 on the three-dimensional space, the control section 260 can control such movement as described above with high accuracy.

Next, description will be given of an example of the display control of the display object AO, the display control being performed in a case where the target object according to the present embodiment is the electronic equipment 10 including no display region.

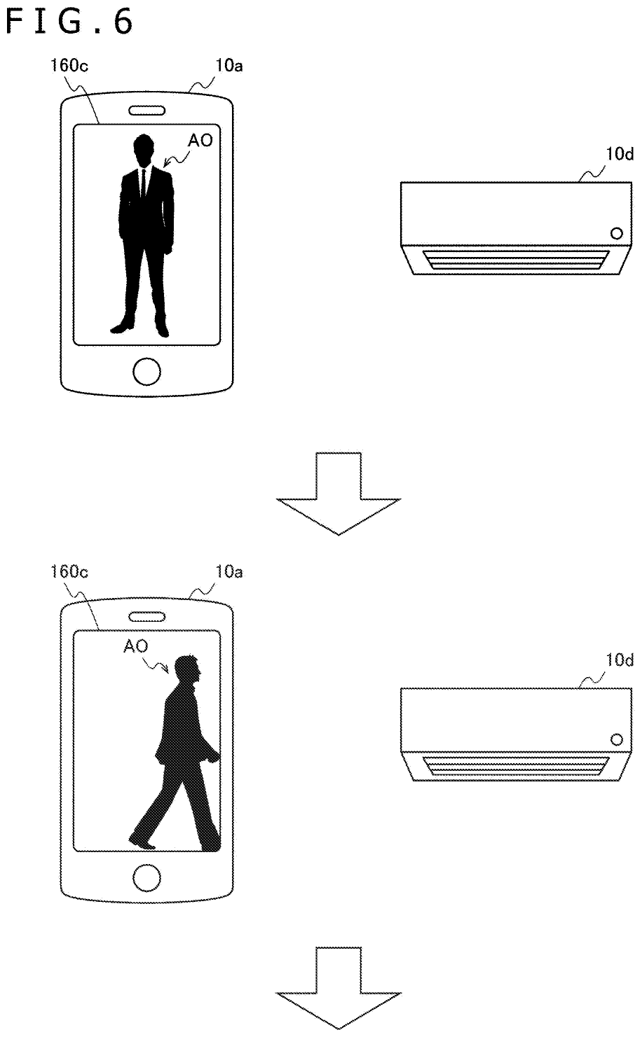

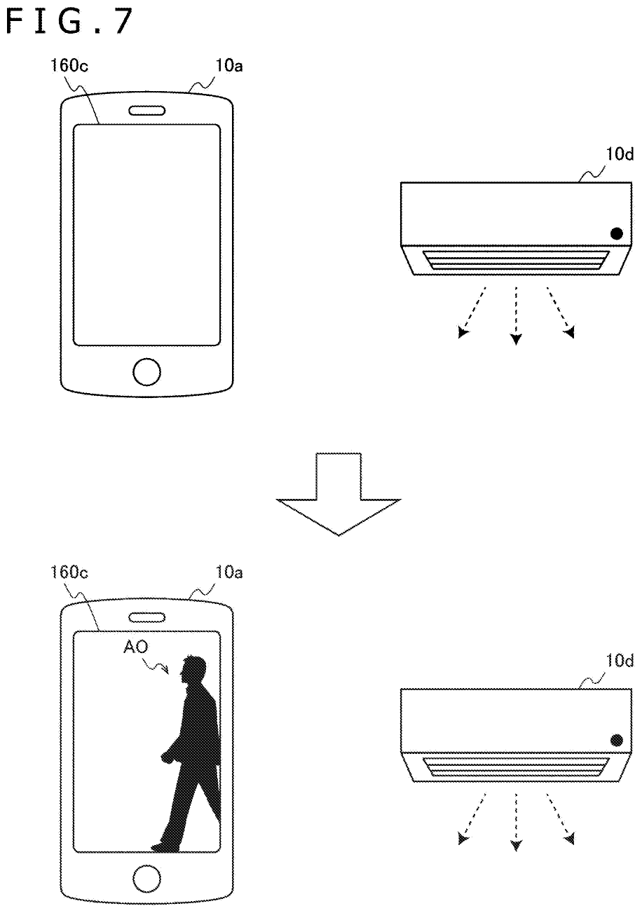

FIGS. 6 and 7 are diagrams illustrating an example of the display control of the display object AO, the display control being performed in a case where the target object according to the present embodiment is the electronic equipment 10 including no display region.

Note that FIGS. 6 and 7 illustrate an example in which the electronic equipment 10a corresponding to the movement source of the display object AO is a smartphone whereas the electronic equipment 10d corresponding to the movement destination of the display object AO is an air conditioner.

In addition, in the example illustrated in FIGS. 6 and 7, the electronic equipment 10d is positioned to the right of the electronic equipment 10a on the three-dimensional space.

In this case, first, as depicted in the upper stage in FIG. 6, the user views the display object AO displayed on the display section 160a of the electronic equipment 10a and has conversation with the conversational agent.

Here, for example, assumed is a case where the user utters the desire of the user to operate a function (for example, starting a fan) of the electronic equipment 10d corresponding to an air conditioner.

In this case, the control section 260 of the information processing server 20 causes the animation generation section 240 to generate, in the display section 160a of the electronic equipment 10a that is displaying the display object AO, an animation related to representation of the display object AO moving toward the electronic equipment 10d.

In addition, as depicted in the lower stage in FIG. 6, the control section 260 dynamically controls display of the above-described animation provided by the display section 160a of the electronic equipment 10a.

In addition, after the display control of the animation described above, the control section 260 may perform control such that the electronic equipment 10d performs a predetermined function (for example, starting the fan) as depicted in the upper stage in FIG. 7.

In addition, after the function control of the electronic equipment 10d described above, the control section 260 causes the animation generation section 240 to generate, in the display section 160a of the electronic equipment 10a, an animation for representation of the display object AO moving from the electronic equipment 10d.

In addition, as depicted in the lower stage in FIG. 7, the control section 260 dynamically controls display of the above-described animation provided by the display section 160a of the electronic equipment 10a.

The control as described above enables rendering that makes the conversational agent appear to have moved to control the function of the electronic equipment 10d. This is expected to be effective in giving the user the feeling that the conversational agent is actually present on the three-dimensional space.

The specific example of the display control of the display object AO has been described hereinabove, the control being performed in the case where the target object according to the present embodiment is the electronic equipment 10.

Note that, as described above, the target object according to the present embodiment may include various structures 30 preset on the three-dimensional space, in addition to the electronic equipment 10.

In this case, the control section 260 may dynamically control the display of an animation related to representation of the display object AO moving out from the display region toward the structure 30 with reference to the display region.

Note that the structure 30 according to the present embodiment may include a space that can be defined by multiple structures 30 (for example, walls and floors) such as a kitchen, an entrance, and the second floor, in addition to an object formed independently of the other structures 30, such as the above-described door.

Further, the target object according to the present embodiment may include various dynamic objects such as human beings and animals and various static objects such as furniture.

Note that it is sufficient if the positions of the structure 30, the dynamic object, and the static object on the three-dimensional space are stored in the storage section 270 of the information processing server 20 by the position estimation based on object recognition, position estimation utilizing electronic tags assigned, and position designation provided by the user, for example.

In addition, FIGS. 4 to 7 illustrate the case where the display of the animation of the display object AO moving on foot, but the animation of the display object AO is not limited to such an example.

It is sufficient if the animation of the display object AO according to the present embodiment is generated according to movement characteristics of a living organism (for example, a human being, an animal, or the like) or an object (for example, a robot, a vehicle, or the like) imitated by the conversational agent.

In addition, the animation of the display object AO according to the present embodiment may be generated according to a distance between the target object and the electronic equipment 10 corresponding to the movement source.

For example, in a case where the distance between the target object and the electronic equipment 10 corresponding to the movement source has a predetermined value or greater, the control section 260 may cause the animation generation section 240 to generate an animation of the display object AO that appears to be running.

In addition, the animation of the display object AO according to the present embodiment may be generated according to an estimation accuracy for the position of the target object.

For example, in a case where the estimation accuracy for the position of the target object is at a medium level, the control section 260 may cause the animation generation section 240 to generate an animation of the display object AO appearing to jump roughly toward the target object, for example.

On the other hand, in a case where the estimation accuracy for the position of the target object is lower than a predetermined value, the control section 260 may cause the animation generation section 240 to generate an animation of the display object AO appearing to be teleported to somewhere or from somewhere.

On the other hand, in a case where the estimation accuracy for the position of the target object is higher than the predetermined value, the control section 260 can cause the animation generation section 240 to generate a more realistic animation in perspective or other animations.

Further, for example, in a case where the position of the structure 30 such as a table can similarly be estimated with high accuracy, the control section 260 may cause the animation generation section 240 to generate an animation of the display object AO moving toward the target object while avoiding the structure 30 such as a table, for example.

In addition, the animation of the display object AO according to the present embodiment may be generated according to attributes of the target object.

Examples of the above-mentioned attributes include whether or not the target object corresponds to the electronic equipment 10 (whether or not the target object can be electrically controlled), and whether or not there is a possibility that the position of the target object frequently varies (whether or not the target object is mobile equipment or whether or not the target object is a dynamic object), for example.

In addition, examples of the attributes include, in a case where the target object is the electronic equipment 10, whether or not the target object is provided with the display region, or include, in a case where the target object is provided with the display region, the size of the display region, whether or not color display is enabled, or whether or not the target object includes a user interface.

By way of example, in a case where the display object AO is moved from the electronic equipment 10 with a relatively small display region to the electronic equipment 10 with a relatively large display region, the control section 260 may cause the animation generation section 240 to generate an animation of the display object AO appearing to gradually grow mammoth.

As described above, the animation of the display object AO according to the present embodiment can flexibly be generated under the various conditions.

### <<1.5. Identification of Target Object>>

Now, the identification of the target object according to the present embodiment will be described in detail. For example, as in the example illustrated in FIG. 1, in a case where multiple candidates that can be the target object are present on the three-dimensional space, the target object corresponding to the destination needs to be identified from the multiple candidates.

By way of example, the control section 260 of the information processing server 20 according to the present embodiment may identify the target object on the basis of designation provided by the user.

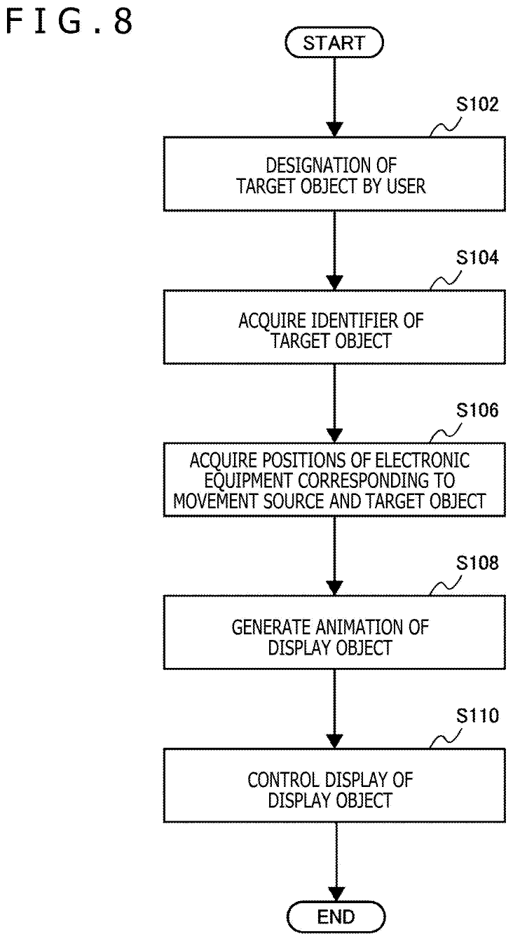

FIG. 8 is a flowchart illustrating an example of a flow of the identification of the target object based on the designation provided by the user, and the display control of the display object AO, according to the present embodiment.

In the example illustrated in FIG. 8, first, the user designates the target object (S102).

The above-described designation may be provided, for example, by the user selecting the name of a desired target object from a candidate list displayed on the display section 160 of the electronic equipment 10.

In addition, the above-described designation may be provided, for example, by the user uttering or inputting the name of a desired target object.

For this purpose, the storage section 270 of the information processing server 20 stores the names of candidates each of which can be the target object.

Now, the control section 260 according to the present embodiment acquires an identifier of the target object on the basis of the name of the target object designated in step S102 (S104).

For this purpose, the storage section 270 according to the present embodiment stores the name of the target object in association with the identifier.

Now, the control section 260 according to the present embodiment acquires, from the storage section 270, the positions of the electronic equipment 10 corresponding to the movement source and the target object (S106).

For this purpose, the storage section 270 according to the present embodiment stores the identifier of the target object in association with the position of the target object on the three-dimensional space.

Then, the control section 260 according to the present embodiment causes the animation generation section 240 to generate an animation of the display object AO according to the positions of the electronic equipment 10 corresponding to the movement source and the target object acquired in step S106 (S108).

At this time, the control section 260 may cause the animation generation section 240 to generate an animation according to the attributes of the target object and the like, as described above.

Now, the control section 260 according to the present embodiment controls the animation of the display object AO generated in step S108, in such a manner that the animation is displayed on the electronic equipment 10 corresponding to the movement source or the electronic equipment 10 corresponding to the movement destination.

As described above, the control section 260 according to the present embodiment may control the display of the display object AO on the basis of the position of the target object on the three-dimensional space, the position being associated with the identifier of the identified target object.

Note that, in a case where the control section 260 causes the electronic equipment 10 corresponding to the movement destination to display the animation, the identifier acquired in step S104 may be, for example, a network identifier such as an IP address. The control section 260 can control the electronic equipment 10 corresponding to the movement destination by using the above-described network identifier.

The example of the flow has been described hereinabove, the flow being used in a case where the control section 260 according to the present embodiment identifies the target object on the basis of the designation provided by the user.

Meanwhile, the control section 260 according to the present embodiment may identify the target object on the basis of the direction designated by the user.

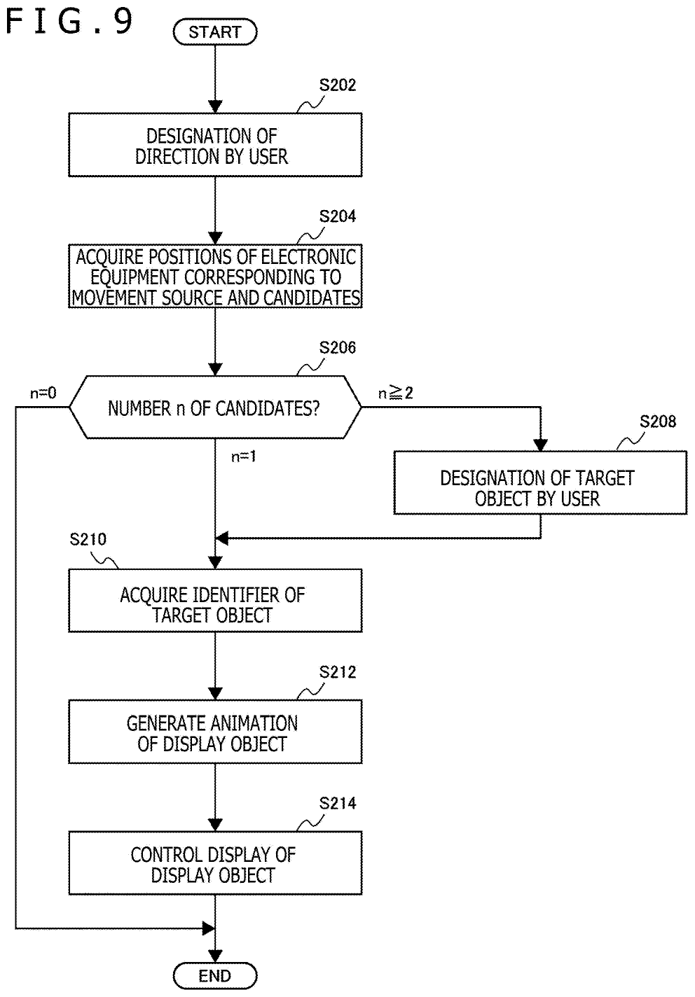

FIG. 9 is a flowchart illustrating an example of a flow of the identification of the target object based on the direction designated by the user, and the display control of the display object AO, according to the present embodiment.

In the example illustrated in FIG. 9, first, the user designates the direction (S202).

The above-mentioned designation of the direction may be preformed by, for example, the user performing a flick operation on the display section 160 of the electronic equipment 10 or other operations.

Then, the control section 260 according to the present embodiment acquires, from the storage section 270, the position of the electronic equipment 10 corresponding to the movement source and the positions of candidates present in the direction designated in step S202 (with reference to the position of the electronic equipment 10 corresponding to the movement source) (S204).

Then, the control section 260 according to the present embodiment performs control according to the number n (n is an integer) of the candidates for which the positions have been acquired in step S204 (S206).

Here, in a case where the number n of the candidates is 0 (S206: n=0), the control section 260 may end a series of processing operations related to the display control of the display object AO and may transition to a standby state.

On the other hand, in a case where the number n of the candidates is two or more (S206: n≥2), the control section 260 may perform, for example, display of the candidate list or the like to urge the user to designate the target object (S208).

On the other hand, in a case where the number n of the candidates is one (S206: n=1), the control section 260 may identify, as the target object, the candidate for which the position is acquired in step S204.

Then, the control section 260 according to the present embodiment acquires the identifier of the target object from the storage section 270 (S210).

The subsequent processing in steps S212 and S214 may be the same as the processing in steps S108 and S110 depicted in FIG. 8, and detailed description of the processing is hence omitted.

The example of the flow has been described hereinabove, the flow being used in a case where the control section 260 according to the present embodiment identifies the target object on the basis of the direction estimated by the user.

Now, description will be given of the identification of the target object based on a movement trigger related to a context according to the present embodiment.

The control section 260 according to the present embodiment may identify the target object corresponding to the movement trigger on the basis of detection of the movement trigger related to the context.

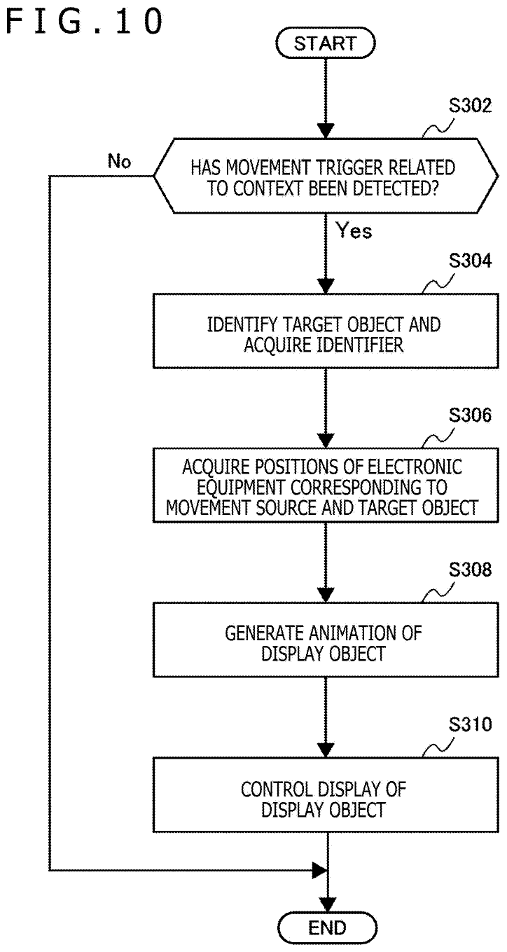

FIG. 10 is a flowchart illustrating an example of a flow of the identification of the target object based on detection of the movement trigger related to the context, and the display control of the display object AO, according to the present embodiment.

In the case of the example illustrated in FIG. 10, first, the control section 260 determines whether or not the movement trigger related to the context is detected (S302).

Here, in a case where the movement trigger related to the context is not detected (S302: No), the control section 260 may end the series of processing operations related to the display control of the display object AO and may transition to the standby state.

On the other hand, in a case where the movement trigger related to the context is detected (S302: Yes), the control section 260 identifies the target object on the basis of the detected movement trigger, and acquires the identifier of the target object from the storage section 270 (S304).

The subsequent processing in steps S306 to S310 may be the same as the processing in steps S106 to S110 depicted in FIG. 8, and detailed description of the processing is hence omitted.

Now, the context and the movement trigger according to the present embodiment will be described with reference to specific examples.

The context according to the present embodiment may include, for example, the position of the user. In this case, the movement trigger may be the position of the user being within a predetermined range.

For example, the control section 260 may use, as the movement trigger, the user sitting down in front of the electronic equipment 10 corresponding to a TV, to identify the electronic equipment 10 as the target object.

In addition, for example, the control section 260 may use, as the movement trigger, the user entering the kitchen to identify, as the target object, the electronic equipment 10 located in the kitchen.

In addition, the context according to the present embodiment may include, for example, speech and behavior of the user. In this case, the movement trigger may be predetermined speech and behavior realized by the user.

For example, the control section 260 may use, as a trigger, the utterance of the user “I wonder if there are any interesting programs on TV” to identify, as the target object, the electronic equipment 10 corresponding to a TV.

In addition, for example, the control section 260 may use, as the movement trigger, the user changing into running clothes, to identify, as the target object, the electronic equipment 10 corresponding to a wearable device often worn by the user during running.

In addition, the context according to the present embodiment may include the state of the electronic equipment 10. In this case, the movement trigger may be the state of the electronic equipment 10 transitioning to a predetermined state.

For example, on the basis of a certain electronic equipment 10 being started or an application in a certain electronic equipment 10 being initiated, the control section 260 may identify the electronic equipment 10 as the target object.

In addition, the context according to the present embodiment may include surrounding environments of the user. In this case, the movement trigger may be detection of a predetermined sound, visual information, tactile information, an odor, or the like around the user.

For example, the control section 260 may use, as the movement trigger, a sound indicating the end of cooking in an oven, to identify, as the target object, the electronic equipment 10 located in the kitchen.

As described hereinabove, the control section 260 according to the present embodiment can identify the target object on the basis of the movement trigger related to the various contexts.

Note that, in a case where multiple candidates are detected in step S206 depicted in FIG. 9, the control section 260 may identify the target object on the basis of the movement trigger related to the context.

<<1.6. Registration of Candidates that can Each be Used as Target Object>>

Now, a method for registering a candidate that can be used as a target object according to the present embodiment will be described with reference to specific examples.

As described above, the control section 260 according to the present embodiment can identify a target object from multiple candidates and perform display control on the display object AO, depending on the target object.

The implementation of the above-described operation requires processing for registering in advance, in the storage section 270 of the information processing server 20, the identifiers of candidates that can each be used as the target object, the positions of the candidates on the three-dimensional space, the names and attributes of the candidates, and the like in association with one another.

The registration as described above is assumed to have several patterns.

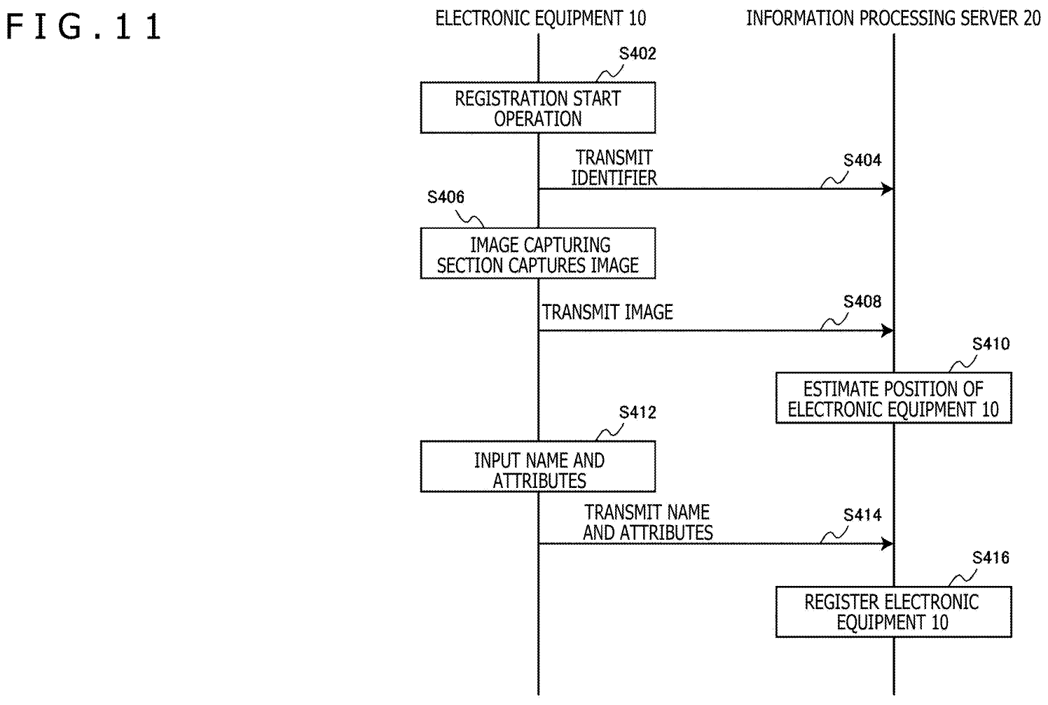

First, a flow of registration processing will be described, the registration processing being executed in a case where an object to be registered is the electronic equipment 10 including the image capturing section 120. FIG. 11 is a sequence diagram illustrating an example of a flow of registration processing executed in a case where the object to be registered is the electronic equipment 10 including the image capturing section 120, according to the present embodiment.

In the case of the example illustrated in FIG. 11, first, the user uses the electronic equipment 10 to perform a registration start operation (S402).

The registration start operation is performed according to a user interface displayed on the display section 160 of the electronic equipment 10, for example.

Then, the control section 140 of the electronic equipment 10 transmits the identifier of the electronic equipment 10 to the information processing server 20 via the communication section 180 (S404).

Note that the identifier of the electronic equipment 10 may be transmitted to the information processing server 20 on the basis of an input operation or a transmission operation performed by the user.

Next, the user captures an image by using the image capturing section 120 of the electronic equipment 10 (S406).

Then, the control section 140 of the electronic equipment 10 transmits the image captured in step S406 to the information processing server 20 via the communication section 180 (S408).

At this time, the control section 140 may also transmit, to the information processing server 20, posture information collected by a sensor provided in the electronic equipment 10, for example.

Then, the position estimation section 220 of the information processing server 20 estimates the position of the electronic equipment 10 on the predetermined three-dimensional space on the basis of the image received in step S408 and the three-dimensional map information stored in the storage section 270 (S410).

Next, the user uses the electronic equipment 10 to input the name and attributes of the electronic equipment 10 (S412).

The control section 140 of the electronic equipment 10 transmits the name and attributes input in step S412, to the information processing server 20 via the communication section 180 (S414).

Note that the control section 140 may automatically acquire and transmit the name and attributes of the electronic equipment 10 to the information processing server 20.

Then, the control section 260 of the information processing server 20 causes the identifier of the electronic equipment 10 received in step S404, the position of the electronic equipment 10 estimated in step S410, and the name and attributes of the electronic equipment 10 received in step S414 to be registered (stored) in the storage section 270 in association with one another (S416).

As described above, the storage section 270 of the information processing server 20 according to the present embodiment may store the position of the target object, the position being acquired on the basis of the image captured by the target object in the three-dimensional space.

The example of the flow of the registration processing has been described, the registration processing being executed in the case where the object to be registered is the electronic equipment 10 including the image capturing section 120.

Note that, in the example illustrated in FIG. 11, illustrated is the case where the information processing server 20 estimates the position of the electronic equipment 10 on the basis of the image captured by the electronic equipment 10. However, the electronic equipment 10 may estimate the position of the electronic equipment 10 on the basis of the image captured by the electronic equipment 10 itself, and transmit, to the information processing server 20, information related to the estimated position.

Next, a flow of registration processing will be described, the registration processing being executed in a case where the object to be registered is the electronic equipment 10 that does not include the image capturing section 120 but includes the display section 160.

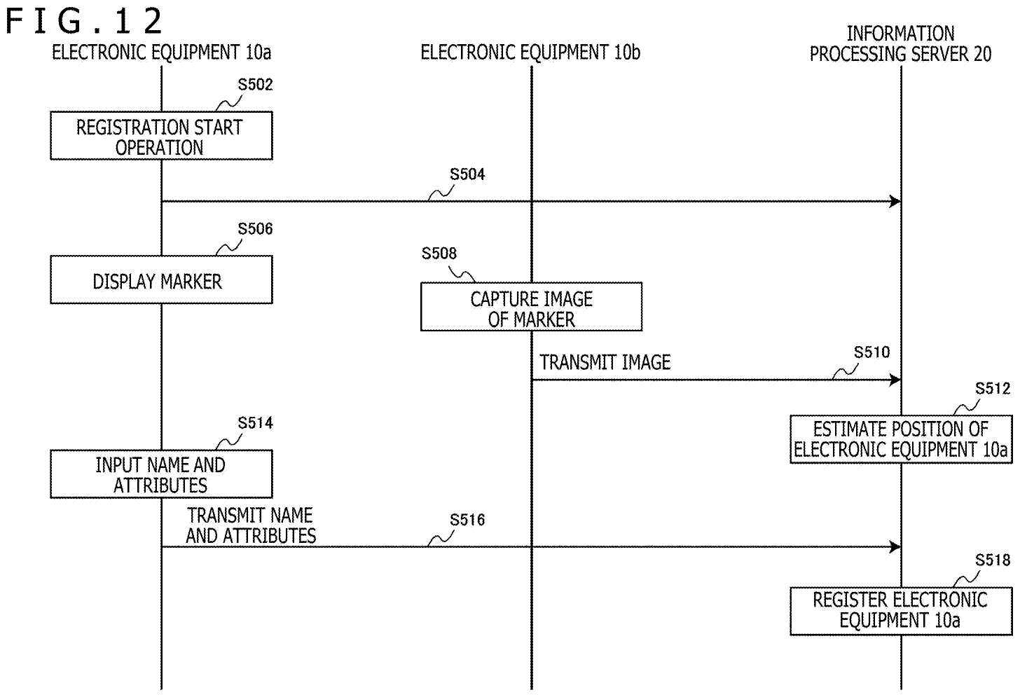

FIG. 12 is a sequence diagram illustrating an example of a flow of registration processing executed in a case where the object to be registered is the electronic equipment 10 not including the image capturing section 120 but including the display section 160, according to the present embodiment.

Note that FIG. 12 assumes that the object to be registered is the electronic equipment 10a.

In this case, first, the user uses the electronic equipment 10a to perform a registration start operation (S502).

Then, a control section 140a of the electronic equipment 10a transmits the identifier of the electronic equipment 10a to the information processing server 20 via a communication section 180a (S504).

Next, the control section 140a of the electronic equipment 10a causes the display section 160a to display a marker for self-position estimation (S506).

It is sufficient if the above-described marker has any unique shape that is not present on the three-dimensional space.

Then, the user uses the electronic equipment 10b to capture an image of the marker displayed on the display section 160a of the electronic equipment 10a (S508).

Next, a control section 140b of the electronic equipment 10b transmits the image captured in step S508 to the information processing server 20 via a communication section 180b (S510).

Subsequently, the position estimation section 220 of the information processing server 20 estimates the position of the electronic equipment 10a on the predetermined three-dimensional space on the basis of the image received in step S510 and the three-dimensional map information stored in the storage section 270 (S512).

Note that, at this time, the position estimation section 220 may first estimate the position of the electronic equipment 10b on the basis of the image received in step S510 and the three-dimensional map information stored in the storage section 270, and then estimate the position of the electronic equipment 10a on the basis of the position of the electronic equipment 10b, the three-dimensional map information, and the position of the marker in the image.

Then, the user uses the electronic equipment 10a to input the name and attributes of the electronic equipment 10a (S514).

The control section 140a of the electronic equipment 10a transmits the name and attributes input in step S514, to the information processing server 20 via the communication section 180a (S516).

Then, the control section 260 of the information processing server 20 causes the identifier of the electronic equipment 10a received in step S504, the position of the electronic equipment 10a estimated in step S512, and the name and attributes of the electronic equipment 10a received in step S518 to be registered (stored) in the storage section 270 in association with one another (S518).

As described above, the storage section 270 of the information processing server 20 according to the present embodiment may store the position of the target object, the position being acquired on the basis of the image of the target object, the image being captured in the three-dimensional space, more specifically, on the basis of the image of the marker displayed by the target object.

The example of the flow of the registration processing has been described, the registration processing being executed in the case where the object to be registered is the electronic equipment 10 that does not include the image capturing section 120 but includes the display section 160.

Note that, in the example illustrated in FIG. 12, illustrated is the case where the information processing server 20 estimates the position of the electronic equipment 10a on the basis of the image captured by the electronic equipment 10b but that the electronic equipment 10b may perform self-position estimation based on the image captured by the electronic equipment 10b itself as well as estimate the position of the electronic equipment 10 and transmit, to the information processing server 20, information related to the estimated positions.

Subsequently, a flow of registration processing will be described, the registration processing being executed in a case where the object to be registered is the electronic equipment 10 that does not include the image capturing section 120 and the display section 160.

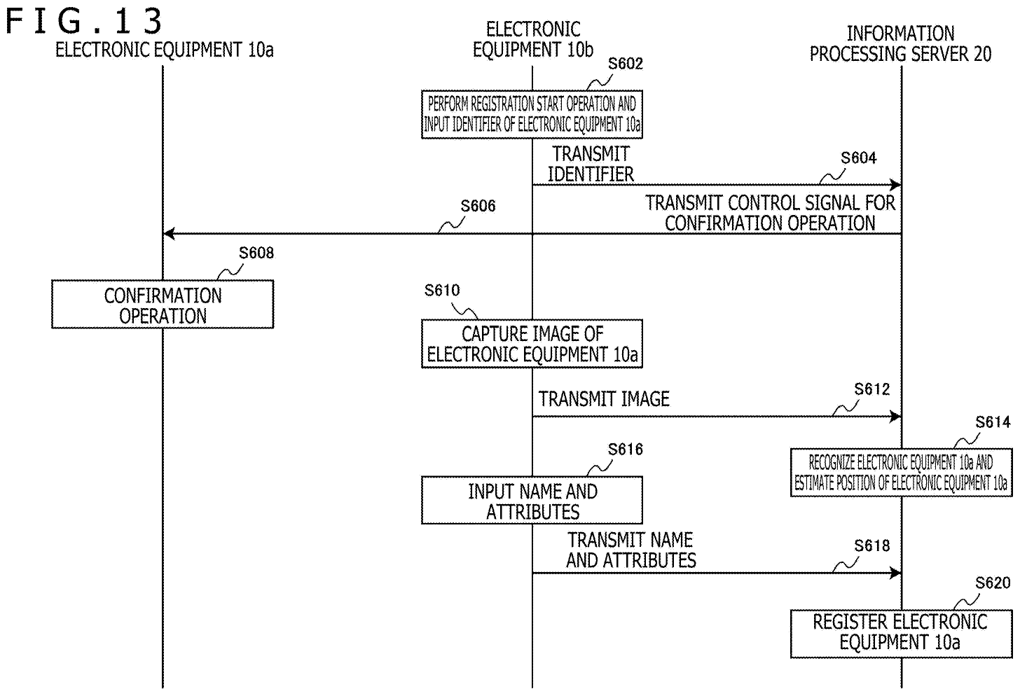

FIG. 13 is a sequence diagram illustrating an example of a flow of registration processing executed in a case where the object to be registered is the electronic equipment 10 that does not include the image capturing section 120 and the display section 160, according to the present embodiment.

Note that FIG. 13 assumes that the object to be registered is the electronic equipment 10a. In addition, FIG. 13 illustrates a flow used in a case where the electronic equipment 10a does not include the operation reception section 110.

In this case, first, the user uses the electronic equipment 10b to perform a registration start operation and to input the identifier of the electronic equipment 10a (S602).

Then, the control section 140b of the electronic equipment 10b transmits the identifier of the electronic equipment 10a input in step S602, to the information processing server 20 via the communication section 180b (S604).

Next, on the basis of the identifier received in step S604, the control section 260 of the information processing server 20 transmits a control signal for a confirmation operation to the electronic equipment 10a via the communication section 280.

Subsequently, the control section 140a of the electronic equipment 10a performs control to execute the confirmation operation, on the basis of the control signal received in step S606 (S608).

Here, the above-described confirmation operation may be any of various operations performed by the user to confirm whether the object to be registered identified by the identifier input in step S602 is as intended by the user. The confirmation operation may be, for example, lighting of a lamp or output of a beep sound.

Then, the user confirms that the object to be registered is as intended by the user, on the basis of the confirmation operation performed in step S608, and uses the electronic equipment 10b to capture an image of the appearance of the electronic equipment 10a (S610).

Next, the control section 140b of the electronic equipment 10b transmits the image captured in step S610 to the information processing server 20 via the communication section 180b (S612).

Subsequently, the recognition section 230 of the information processing server 20 performs object recognition of the electronic equipment 10b on the basis of the image received in step S612. In addition, the position estimation section 220 estimates the position of the electronic equipment 10a on the predetermined three-dimensional space on the basis of the image received in step S612, a recognition result from the recognition section 230, and the three-dimensional map information stored in the storage section 270 (S614).

Then, the user uses the electronic equipment 10b to input the name and attributes of the electronic equipment 10a (S616).

The control section 140b of the electronic equipment 10b transmits the name and attributes input in step S514, to the information processing server 20 via the communication section 180b (S618).

Then, the control section 260 of the information processing server 20 causes the identifier of the electronic equipment 10a received in step S604, the position of the electronic equipment 10a estimated in step S614, and the name and attributes of the electronic equipment 10a received in step S618 to be registered (stored) in the storage section 270 in association with one another (S620).

As described above, the storage section 270 of the information processing server 20 according to the present embodiment may store the position of the target object, the position being acquired on the basis of the image of the target object, the image being captured in the three-dimensional space, more specifically, on the basis of the shape of the target object included in the image.

Note that FIG. 13 illustrates the case where the object to be registered is the electronic equipment 10a but that, even in a case where the object to be registered is the structure 30, a similar flow can be used for registration except for the processing in step S606 and S608.

### 2. Hardware Configuration Example

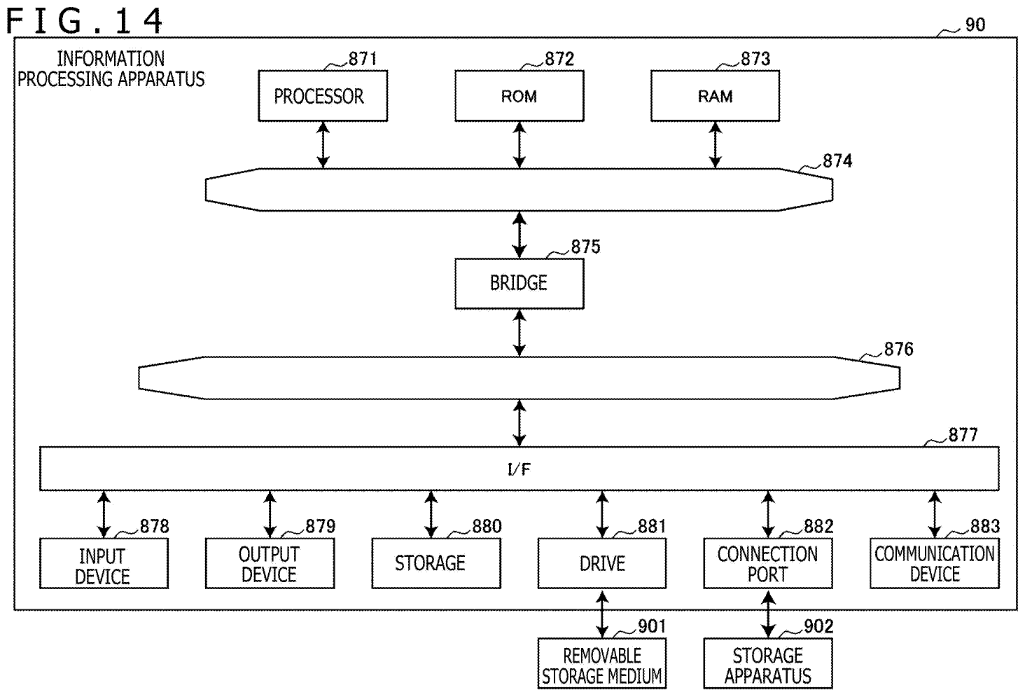

Now, a hardware configuration example that is common to the electronic equipment 10 and the information processing server 20 according to an embodiment of the present disclosure will be described. FIG. 14 is a block diagram illustrating a hardware configuration example of an information processing apparatus 90 according to an embodiment of the present disclosure. The information processing apparatus 90 may be an apparatus having a hardware configuration equivalent to that of each of the above-described apparatuses.

As depicted in FIG. 14, the information processing apparatus 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that a hardware configuration is an example and that some of the components of the information processing apparatus 90 may be omitted. In addition, the information processing apparatus 90 may further include components other than those depicted herein.

### (Processor 871)

The processor 871, for example, functions as an arithmetic processing apparatus or a control apparatus, and controls the operations of the components in general or some of the operations on the basis of various programs recorded in the ROM 872, the RAM 873, the storage 880, or a removable storage medium 901.

### (ROM 872, RAM 873)

The ROM 872 is means for storing programs that are read into the processor 871, data used for arithmetic operations, and the like. The RAM 873, for example, temporarily or permanently stores programs that are read into the processor 871, parameters varying as appropriate when the programs are executed, and the like.

### (Host Bus 874, Bridge 875, External Bus 876, Interface 877)

The processor 871, the ROM 872, and the RAM 873 are connected to each other, for example, via the host bus 874 that can transmit data at high speed. Meanwhile, the host bus 874 is connected, for example, via the bridge 875, to the external bus 876 that transmits data at relatively low speed. In addition, the external bus 876 is connected to various components via the interface 877.

### (Input Device 878)

The input device 878 as used herein includes, for example, a mouse, a keyboard, a touch panel, a button, a switch, a lever, and the like. Further, as the input device 878, a remote controller (hereinafter, a remote) that can transmit control signals by utilizing infrared rays and other radio waves may be used. In addition, the input device 878 includes a sound input device such as a microphone.

### (Output Device 879)

The output device 879 is a device that can visually or auditorily notify the user of information acquired, and is, for example, a display device such as CRT (Cathode Ray Tube), an LCD, or an organic EL, an audio output device such as a speaker or a headphone, a printer, a cellular phone, or a fax machine. In addition, the output device 879 according to the present disclosure includes various vibration devices that can output haptic stimuli.

### (Storage 880)

The storage 880 is a device for storing various kinds of data. The storage 880 as used herein is, for example, a magnetic storage device such as a hard disk drive (HDD), a semiconductor storage device, an optical storage device, a magneto-optical storage device, or the like.

### (Drive 881)

The drive 881 is, for example, an apparatus that reads information recorded in the removable storage medium 901 such as a magnetic disk, an optical disc, a magneto-optical disc, or a semiconductor memory or writes information into the removable storage medium 901.

### (Removable Storage Medium 901)

The removable storage medium 901 is, for example, a DVD medium, a Blu-ray (registered trademark) medium, an HD DVD medium, or any of various semiconductor storage media. Needless to say, the removable storage medium 901 may be, for example, an IC card, electronic equipment, or the like on which a non-contact IC chip is mounted.

### (Connection Port 882)

The connection port 882 is a port to which external connection equipment 902 is connected, such as a USB (Universal Serial Bus) port, an IEEE 1394 port, an SCSI (Small Computer System Interface), an RS-232C port, or an optical audio terminal.

### (External Connection Equipment 902)

The external connection equipment 902 is, for example, a printer, a portable music player, a digital camera, a digital video camera, an IC recorder, or the like.

### (Communication Device 883)

The communication device 883 is a communication device for connection to a network, and is, for example, a communication card for a wired or wireless LAN, Bluetooth (registered trademark), or WUSB (Wireless USB), a router for optical communication, a router for ADSL (Asymmetric Digital Subscriber Line), any of modems for various types of communication, or the like.

### 3. Summary

As described above, the information processing server 20 that controls the multiple pieces of electronic equipment 10 according to an embodiment of the present disclosure includes the control section 260 that controls the display, in the display region present on the predetermined three-dimensional space, of the display object AO corresponding to the conversational agent that supports provision of the function for the user while engaging in conversation with the user.

In addition, a feature of the control section 260 according to an embodiment of the present disclosure is that the control section 260 dynamically controls the display of the animation related to at least any one of representation of the display object AO moving out from the display region or representation of the display object AO moving into the display region, on the basis of the relative position between the target object present on the three-dimensional space and the display object.

The above-described configuration enables achievement of rendering of movement of the conversational agent, the rendering being less uncomfortable for the user.

The preferred embodiment of the present disclosure has been described above in detail with reference to the accompanying drawings, but the technical scope of the present disclosure is not limited to such an example. It is comprehended that a person having ordinary knowledge in the technical field of the present disclosure may obviously arrive at various alterations or modifications within the range of technical concepts recited in claims and that the alterations and modifications reasonably belong to the technical scope of the present disclosure.

In addition, the steps related to the processing described herein need not necessarily be chronologically processed in the order described in the flowcharts or sequence diagrams. For example, the steps related to the processing of each apparatus may be processed in an order different from the described order or in parallel.

In addition, the series of processing operations performed by each apparatus described herein may be implemented using any of software, hardware, or a combination of software and hardware. A program constituting software is, for example, provided inside or outside each apparatus and is pre-stored in a non-transitory computer readable medium. Further, for example, when executed by the computer, each program is read into the RAM and executed by various processors. The above-described storage medium is, for example, a magnetic disk, an optical disc, a magneto-optical disc, a flash memory, or the like. In addition, the above-described computer programs may be delivered, for example, via the network without using a storage medium.

In addition, the effects described herein are only descriptive or illustrative and not restrictive. In other words, in addition to or instead of the above-described effects, the technique according to the present disclosure can produce other effects that are clear to a person skilled in the art from the description of the specification.

Note that the following configurations also belong to the technical scope of the present disclosure.

(1)

An information processing apparatus including:
a control section that controls display, in a display region present on a predetermined three-dimensional space, of a display object corresponding to a conversational agent that supports provision of a function for a user while engaging in conversation with the user, in which
the control section dynamically controls display of an animation related to at least any one of representation of the display object moving out from the display region or representation of the display object moving into the display region, on the basis of a relative position between a predetermined target object present on the three-dimensional space and the display object.
   (2)

The information processing apparatus according to (1), in which
the control section dynamically controls display of an animation related to at least any one of representation of the display object moving out from the display region toward the target object with reference to the display region or representation of the display object moving into the display region from the target object with reference to the display region.
   (3)

The information processing apparatus according to (1) or (2), in which
the target object includes predetermined electronic equipment that executes a function to be provided to the user, and
the control section dynamically controls display of an animation related to representation of the display object moving out from the display region toward the electronic equipment with reference to the display region.
   (4)

The information processing apparatus according to (3), in which
the control section further controls execution of the function performed by the electronic equipment.
   (5)

The information processing apparatus according to (3), in which
the control section dynamically controls display of an animation related to at least any one of representation, in a first display region that is displaying the display object, of the display object moving toward a second display region provided in the electronic equipment or representation, in the second display region, of the display object moving from the first display region.
   (6)

The information processing apparatus according to (1) or (2), in which
the target object includes a predetermined structure present on the three-dimensional space, and
the control section dynamically controls display of an animation related to representation of the display object moving out from the display region toward the structure with reference to the display region.
   (7)

The information processing apparatus according to any one of (1) to (6), in which
the control section controls display of the display object on the basis of a position of the target object on the three-dimensional space, the position being associated with an identifier of the target object identified.
   (8)

The information processing apparatus according to (7), in which
the control section identifies the target object on the basis of designation provided by a user.
   (9)

The information processing apparatus according to (7), in which
the control section identifies the target object on the basis of a direction designated by a user.
   (10)

The information processing apparatus according to (7), in which
the control section identifies the target object on the basis of detection of a movement trigger related to a context.
   (11)

The information processing apparatus according to (10), in which
the context includes speech and behavior of the user.
   (12)

The information processing apparatus according to (10), in which
the context includes a position of the user.
   (13)

The information processing apparatus according to any one of (1) to (12), further including:
a storage section that stores three-dimensional map information related to the three-dimensional space.
   (14)

The information processing apparatus according to (13), in which
the storage section stores an identifier of the target object and a position of the target object on the three-dimensional space in association with each other.
   (15)

The information processing apparatus according to (14), in which
the storage section stores the position of the target object, the position being acquired on the basis of an image captured by the target object in the three-dimensional space.
   (16)

The information processing apparatus according to (14), in which
the storage section stores the position of the target object, the position being acquired on the basis of an image of the target object, the image being captured in the three-dimensional space.
   (17)

The information processing apparatus according to (16), in which
the storage section stores the position of the target object, the position being acquired on the basis of a marker displayed by the target object in the three-dimensional space.
   (18)

The information processing apparatus according to (16), in which
the storage section stores the position of the target object present on the three-dimensional space, the position being acquired on the basis of a shape of the target object.
   (19)

An information processing method including:
by a processor, controlling display, in a display region present on a predetermined three-dimensional space, of a display object corresponding to a conversational agent that supports provision of a function for a user while engaging in conversation with the user, in which
the controlling further includes dynamically controlling display of an animation related to at least any one of representation of the display object moving out from the display region or representation of the display object moving into the display region, on the basis of a relative position between a predetermined target object present on the three-dimensional space and the display object.
   (20)

A program causing a computer to function as:
an information processing apparatus including
   a control section that controls display, in a display region present on a predetermined three-dimensional space, of a display object corresponding to a conversational agent that supports provision of a function for a user while engaging in conversation with the user,
   the control section dynamically controlling display of an animation related to at least any one of representation of the display object moving out from the display region or representation of the display object moving into the display region, on the basis of a relative position between a predetermined target object present on the three-dimensional space and the display object.

### REFERENCE SIGNS LIST

10: Electronic equipment
110: Operation reception section
120: Image capturing section
130: Sound input section
140: Control section
150: Sound output section
160: Display section
170: Storage section
180: Communication section
20: Information processing server
210: Map generation section
220: Position estimation section
230: Recognition section
240: Animation generation section
250: Agent management section
260: Control section
270: Storage section
280: Communication section
30: Structure

1. An information processing apparatus comprising:
a control section that controls display, in a display region present on a predetermined three-dimensional space, of a display object corresponding to a conversational agent that supports provision of a function for a user while engaging in conversation with the user, wherein
the control section dynamically controls display of an animation related to at least any one of representation of the display object moving out from the display region or representation of the display object moving into the display region, on a basis of a relative position between a predetermined target object present on the three-dimensional space and the display object.

2. The information processing apparatus according to claim 1, wherein
the control section dynamically controls display of an animation related to at least any one of representation of the display object moving out from the display region toward the target object with reference to the display region or representation of the display object moving into the display region from the target object with reference to the display region.

3. The information processing apparatus according to claim 1, wherein
the target object includes predetermined electronic equipment that executes a function to be provided to the user, and
the control section dynamically controls display of an animation related to representation of the display object moving out from the display region toward the electronic equipment with reference to the display region.

4. The information processing apparatus according to claim 3, wherein
the control section further controls execution of the function performed by the electronic equipment.

5. The information processing apparatus according to claim 3, wherein
the control section dynamically controls display of an animation related to at least any one of representation, in a first display region that is displaying the display object, of the display object moving toward a second display region provided in the electronic equipment or representation, in the second display region, of the display object moving from the first display region.

6. The information processing apparatus according to claim 1, wherein
the target object includes a predetermined structure present on the three-dimensional space, and
the control section dynamically controls display of an animation related to representation of the display object moving out from the display region toward the structure with reference to the display region.

7. The information processing apparatus according to claim 1, wherein
the control section controls display of the display object on a basis of a position of the target object on the three-dimensional space, the position being associated with an identifier of the target object identified.

8. The information processing apparatus according to claim 7, wherein
the control section identifies the target object on a basis of designation provided by a user.

9. The information processing apparatus according to claim 7, wherein
the control section identifies the target object on a basis of a direction designated by a user.

10. The information processing apparatus according to claim 7, wherein
the control section identifies the target object on a basis of detection of a movement trigger related to a context.

11. The information processing apparatus according to claim 10, wherein
the context includes speech and behavior of the user.

12. The information processing apparatus according to claim 10, wherein
the context includes a position of the user.

13. The information processing apparatus according to claim 1, further comprising:
a storage section that stores three-dimensional map information related to the three-dimensional space.

14. The information processing apparatus according to claim 13, wherein
the storage section stores an identifier of the target object and a position of the target object on the three-dimensional space in association with each other.

15. The information processing apparatus according to claim 14, wherein
the storage section stores the position of the target object, the position being acquired on a basis of an image captured by the target object in the three-dimensional space.

16. The information processing apparatus according to claim 14, wherein
the storage section stores the position of the target object, the position being acquired on a basis of an image of the target object, the image being captured in the three-dimensional space.

17. The information processing apparatus according to claim 16, wherein
the storage section stores the position of the target object, the position being acquired on a basis of a marker displayed by the target object in the three-dimensional space.

18. The information processing apparatus according to claim 16, wherein
the storage section stores the position of the target object present on the three-dimensional space, the position being acquired on a basis of a shape of the target object.

19. An information processing method comprising:
by a processor, controlling display, in a display region present on a predetermined three-dimensional space, of a display object corresponding to a conversational agent that supports provision of a function for a user while engaging in conversation with the user, wherein
the controlling further includes dynamically controlling display of an animation related to at least any one of representation of the display object moving out from the display region or representation of the display object moving into the display region, on a basis of a relative position between a predetermined target object present on the three-dimensional space and the display object.

20. A program causing a computer to function as:
an information processing apparatus including
a control section that controls display, in a display region present on a predetermined three-dimensional space, of a display object corresponding to a conversational agent that supports provision of a function for a user while engaging in conversation with the user,
the control section dynamically controlling display of an animation related to at least any one of representation of the display object moving out from the display region or representation of the display object moving into the display region, on a basis of a relative position between a predetermined target object present on the three-dimensional space and the display object.
